(19) United States
(12) Patent Application Publication
(10) Pub. No.: US 2026/0202052 A1
(43) Pub. Date: Jul. 16, 2026

(54) BURNER

(71) Applicant: TAIHEIYO ENGINEERING CORPORATION, Tokyo (JP)

(72) Inventors: Seiichi KUMAKURA, Tokyo (JP); Yasushi YAMAMOTO, Tokyo (JP)

(21) Appl. No.: 19/131,913

(22) PCT Filed: Dec. 21, 2023
(86) PCT No.: PCT/JP2023/043076

§ 371 Date: May 21, 2025

(30) Foreign Application Priority Data
Dec. 26, 2022 (WO) PCT/JP2022/047936

(51) Int. Cl. F23D 1/04

(52) U.S. Cl. CPC F23D 1/04; F23D 2900/11402; F23D 2900/21

(57) ABSTRACT

To provide a burner that reduces the amount of primary air while maintaining high momentum, reduces the overall weight, and is less likely to become displaced. A burner 1 includes a cylindrical body 1a, a cylindrical cavity 1b penetrating the body 1a in the axial direction, and a flow passage 1c arranged outside the cavity 1b, in which a fuel F and a primary air A1 flow through the flow passage 1c, and a secondary air A2 flows axially inside the cavity 1b and along an outer circumferential surface 1d of the body 1a. The cross section of the flow passage 1c can be ring-shaped. The burner 1 can be suspended from above and can be moved in the axial direction.

### TECHNICAL FIELD

The present invention relates to a burner that can be fueled by solid powder fuel such as pulverized coal, gas or liquid fuel.

### BACKGROUND ART

The applicant and others have proposed a burner having a solid powder fuel passage and a plurality of air passages arranged concentrically that can reduce the amount of nitrogen oxides generated while maintaining the quality of cement clinker being burned, and that can form an optimal flame in accordance with the type of solid powder fuel being used and so on, while maintaining mechanical reliability (Patent Document 1).

The air passages are a four-channel system consisting of a solid powder fuel flow path, a first air flow path, mainly carrying swirling flow, located adjacent to the solid powder fuel flow path on the outside, a second air flow path, mainly carrying straight flow, located adjacent to the first air flow path on the outside, and a third air flow path, mainly carrying swirling flow, located adjacent to the solid powder fuel flow path on the inside. Independently controlling the air flows of these four channels enables to reduce the amount of nitrogen oxides generated and ensure the combustibility of the solid powder fuel.

### PRIOR ART DOCUMENTS

### Patent Documents

Patent Document 1: Japanese Patent Application Publication No. 2003-279003

### OUTLINE OF THE INVENTION

### Problems to be Solved by the Invention

Although the burner is effective, it uses four air channels, so that the amount of air drawn directly from the atmosphere (hereinafter referred to as “primary air”) is large, and the amount of fuel used is increased to heat the large amount of primary air. On the other hand, reducing the amount of primary air reduces momentum, which leads to a deterioration in the combustibility of solid powder fuel. In addition, since the number of air passages is as many as four channels, the cross section of the burner (cross section perpendicular to the axis) is large, and the overall weight of the burner becomes large. Furthermore, since the burner is inserted into a kiln from a side of a kiln front mantle, the overall length becomes long in a cantilevered state, and the installation of the heavy burner in a cantilevered state causing a problem that it is easily displaced.

The present invention has been made in consideration of the problems with the conventional burners described above, and has an object to provide a burner that reduces the amount of primary air while maintaining high momentum, reduces the overall weight of the burner, and is less likely to become displaced.

### Means of Solving the Problems

In order to achieve the above-mentioned object, the present invention provides a burner characterized by including: a cylindrical body; a cylindrical cavity extending through the body in an axial direction; and a flow passage disposed outside the cavity, wherein a fuel and a primary air flow through the flow passage, and a high-temperature air recovered from a cooler downstream of a kiln (hereinafter referred to as “secondary air”) flows axially inside the cavity and along an outer circumferential surface of the body.

According to the present invention, since only the fuel flow exists in the body other than the cavity (one-channel system), the cross section of the burner can be made small, the burner can be made lighter, the positional deviation due to the burner load is unlikely to occur, and the handling is improved. In addition, by increasing the ejection speed of the fuel flow, ejector effect can be used to draw in the secondary air from the outer peripheral surface side of the burner and the cavity, and even with a single channel of only the fuel flow, the fuel flow can be sandwiched by the secondary air. In other words, by using the secondary air to form a flow like the primary air in a four-channel burner, combustibility is maintained. In addition, since the secondary air is high temperature, the combustion speed is fast. Furthermore, increasing the ejection speed of the fuel flow allows a high momentum to be obtained even with a small amount of primary air, and combustibility can be improved.

In the burner, the cross section of the flow passage disposed outside the cylindrical cavity may be ring-shaped.

Making it possible to suspend the burner from above enables the overall length of the burner to be significantly shortened compared to conventional burners, which can promote the weight reduction of the burner. In addition, since the fuel can be transported by dropping it from above to the burner, the amount of primary air can be reduced. This can reduce the amount of nitrogen oxides emitted from the burning apparatus and the amount of fuel used.

Furthermore, making the burner movable in the axial direction of the burner allows the position of the burner to be easily adjusted. The burner body is lightweight, which improves handling when adjusting the position of the burner. Since a horizontal part of the burner is short, fuel is less likely to accumulate and the flow path is less susceptible to wear out. In addition, the short horizontal part where a gas flow velocity is high and which accelerates the fuel reduces pressure loss.

### Effects of the Invention

As described above, according to the present invention, it is possible to provide a burner which reduces the amount of primary air while maintaining high momentum, reduces the overall weight, and is less likely to become displaced.

### BRIEF DESCRIPTION OF THE DRAWINGS

FIG. 1 Diagrams showing an embodiment of a burner according to the present invention, in which FIG. 1A is a front view and FIG. 1B is a vertical sectional view.

FIG. 2 A schematic diagram for explaining an example of installation of the burner shown in FIG. 1.

### MODE FOR CARRYING OUT THE INVENTION

Next, an embodiment of the present invention will be described in detail with reference to the drawings. In the following description, a case where a burner according to the present invention is used as a burner for a cement kiln will be illustrated.

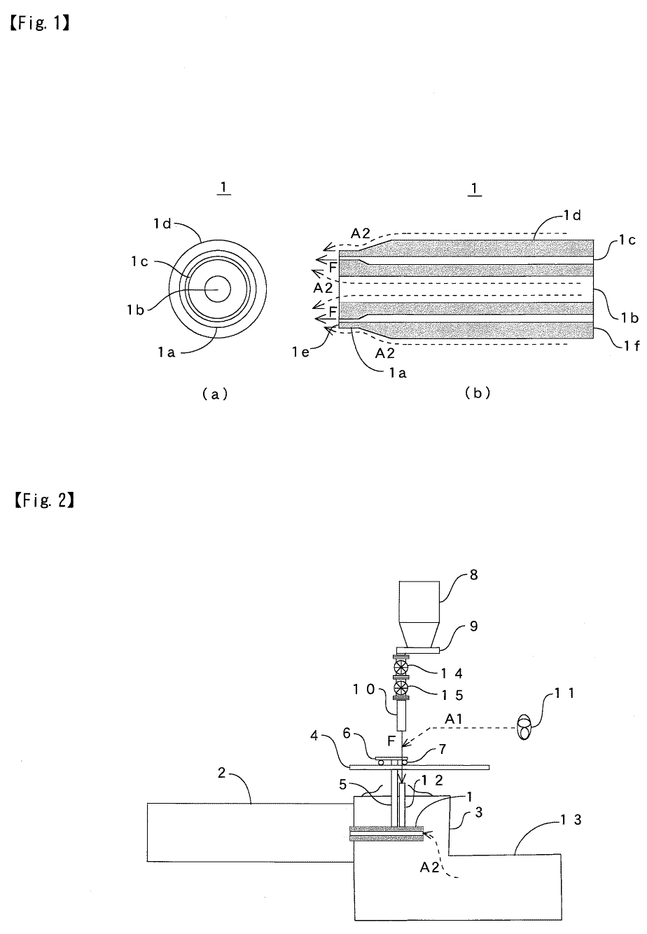

FIG. 1 shows an embodiment of a burner according to the present invention, and the burner 1 includes a generally cylindrical body 1a, a cylindrical cavity 1b extending in the axial direction of the body 1a, and a solid powder fuel passage 1c arranged outside the cavity 1b and having a ring-shaped cross section. The cross section of the cavity 1b is formed larger on a rear end 1f side than on a tip 1e side of the burner 1, and is configured so that solid powder fuel (hereinafter referred to as “fuel”) F such as pulverized coal is ejected at high speed from the tip 1e. A large diameter portion 1d is formed on the outer peripheral surface of the burner 1 except for the tip 1e side, and acts so that a secondary air A2 from a clinker cooler 13 (see FIG. 2) flows toward the center of the burner 1. The cross section of the solid powder fuel passage 1c is not limited to a ring shape and can be other shapes.

As shown in FIG. 2, the burner 1 is suspended from above a front mantle 3 of a cement kiln 2. Adopting the suspended type allows the overall length of the burner 1 to be significantly shortened compared to conventional ones.

Above the kiln front mantle 3 are provided rails 4, a movable part 6 that can move on the rails 4 via wheels 7, and a support part 5, and the burner 1 is supported so that it can move in the axial direction of the cement kiln 2 (axial direction of the burner 1) as well as in the vertical direction.

In addition, above the kiln front mantle 3, a storage tank 8 for a fuel F, a feeder 9, rotary valves 14 and 15, a chute 10, a blower 11, and a conveying pipe 12 are arranged, and the fuel F in the storage tank 8 is dropped and supplied to the burner 1 with the blower 11. Supplying the fuel F by dropping it can reduce the amount of primary air A1.

Next, a cement burning method using the burner 1 will be described with reference to FIGS. 1 and 2.

The position of the burner 1 is adjusted appropriately before the operation of the cement kiln 2. This position adjustment is performed so that the tip 1e of the burner 1 is optimally positioned in the axial direction and the vertical direction of the cement kiln 2 by the movable part 6 and the support part 5. At this time, by making it possible to suspend the burner 1 from above the front mantle 3 of the cement kiln 2, the overall length of the burner 1 can be significantly shortened compared to conventional ones, and the burner is lighter, making it easier to handle and less likely to become displaced after installation.

During cement burning, the fuel F is dropped from the storage tank 8 through the feeder 9 and the rotary valves 14 and 15, and then through the chute 10, and is supplied to the burner 1 with a blower 11 through the conveying pipe 12. Conveying air from the blower 11 becomes a primary air A1 and flows through the solid powder fuel flow passage 1c, and the primary air A1 does not flow inside or outside the body of the burner 1. By increasing the ejection speed of the fuel flow, ejector effect draws in the secondary air A2 from the outer peripheral surface side of the large diameter portion 1d of the burner 1 and the cavity 1b, and supplies it to the cement kiln 2. This enables combustion with high momentum even with a small amount of primary air A1.

In the above embodiment, the burner 1 according to the present invention is used as a burner for a cement kiln, but it can be used in any industrial furnace other than a cement kiln, such as a baking furnace, a heating furnace, a drying furnace, a preheating furnace, etc.

Although the above embodiment illustrates the case where solid powder fuel is used as a fuel, gas or liquid fuel can be used instead of the solid powder fuel. In that case, the solid powder fuel flow passage 1c becomes a gas flow passage or a liquid fuel flow passage. The illustrated embodiments are merely examples and are not intended to limit the technical scope of the present invention.

### DESCRIPTION OF THE REFERENCE NUMERALS

1 burner
2 cement kiln
3 kiln front mantle
4 rail
5 support part
6 movable Part
7 wheels
8 storage tank
9 feeder
10 chute
11 blower
12 conveying piping
13 clinker cooler
14, 15 rotary valves
A1 primary air
A2 secondary air
F fuel

1. A burner comprising:
a cylindrical body;
a cylindrical cavity extending through the body in an axial direction; and
a flow passage disposed outside the cavity,
wherein a fuel and a primary air flow through the flow passage, and a secondary air flows in the cavity and along an outer circumferential surface of the body.

2. The burner as claimed in claim 1, wherein said burner has a ring-shaped cross section.

3. The burner as claimed in claim 1 or 2, wherein said burner can be suspended from above.

4. The burner as claimed in claim 1 or 2, wherein said burner is movable in its axial direction.

5. The burner as claimed in claim 2, wherein said burner can be suspended from above.

6. The burner as claimed in claim 2, wherein said burner is movable in its axial direction.
